(19) United States
(12) Patent Application Publication
(10) Pub. No.: US 2014/0120972 A1
(43) Pub. Date: May 1, 2014

(54) REMOTE SENSING DEVICE AND SYSTEM FOR AGRICULTURAL AND OTHER APPLICATIONS

(71) Applicant: REINOUD JACOB HARTMAN, Nanaimo (CA)

(72) Inventor: REINOUD JACOB HARTMAN, Nanaimo (CA)

(21) Appl. No.: 13/663,360

(22) Filed: Oct. 29, 2012

(51) Int. Cl. H04W 88/02

(52) U.S. Cl. CPC H04W 88/02
USPC 455/509; 455/90.1; 455/517

(57) ABSTRACT

A radio-frequency enabled remote sensing device which can be deployed as a single device or a system of networked devices for gathering environmental data. The device is fully integrated and autonomous. The device operates using solar energy and is battery free due to power saving features of its control module and communications module. The device may operate in a sleep/wake cycle to further conserve power during low light conditions.

### CROSS-REFERENCE TO RELATED APPLICATIONS

This application claims the benefit of U.S. Provisional Patent Application No. 61/554,383 filed in the USPTO on Nov. 1, 2011 the entirety of which is incorporated by reference herein.

### FEDERAL FUNDING

N/A

### FIELD OF THE INVENTION

This invention is related to the field of remote sensing devices and systems for agricultural and other applications that are able to sense environmental conditions over large geographical areas and transmit such data to a base station to enable better resource management decisions.

### BACKGROUND OF THE INVENTION

This invention generally concerns remote sensing devices. Remote sensing devices are well known in the area of agricultural production and environmental monitoring. Such devices sense soil moisture content, rain-fall in a particular area, sunlight irradiation over time, pollution and particulate loads in the atmosphere. These devices range in complexity from satellite coverage systems down to single soil pH monitors. Conventional, complex, remote sensing devices are very expensive and their data must be processed into a usable format. Such data is often out of reach to a small farmer. At their most simple, remote sensing devices do not provide sufficient amounts and types of data for a comprehensive overview of the environmental condition of an agricultural field which may vary from one part of the field to another.

Concerns about sustainable agriculture, feeding a growing global population, water conservation, water use optimization, soil conservation, erosion and maximizing efficiency of agricultural production are becoming increasingly prominent. Therefore there is a requirement for a remote sensing device and system that is able to provide relevant environmental data to a farmer in order to optimize agricultural production. Specifically, a modern farmer requires detailed data on environmental conditions affecting plant growth and health over the agricultural area throughout the growing season. Growing regions may cover a large geographical area such as a prairie state or province or they may be localized to counties and individual farms. This area can have different environmental characteristics so the growing conditions across the area may also vary. There is a further requirement for a remote sensing device and system that provides environmental data specific to a growing region or a portion of a growing region. To collect and collate real-time data over a large agricultural region and efficiently convey the information to a remote user, the sensing devices need to be able to communicate with adjacent devices and with a data-reporting base station in a networked fashion to eliminate the need for an expensive uplink from each device. The sensing devices and systems must also be compact, low cost, fully integrated, self-powered, able to co-exist within conventional farming practice, and maintenance-free so that they can be installed in remote locations over a large agricultural region.

### SUMMARY OF THE INVENTION

In order to satisfy the requirements set out above, my invention provides a remote sensing device that is compact, solar-powered, battery-free, fully integrated and driven by a microprocessor using a plurality of software modules containing neural network elements. My invention operates as a single autonomous device in a local area or as a system comprising a networked array of devices over a larger geographical area such as a farm. The invention is able to acquire, process and transmit data by Radio Frequency (RF) to the operator directly, or via an Ethernet connection, a cellular telephone network, or a combination thereof, to the Internet. My invention provides for the use of portable computer devices to remotely program the device and receive the acquired data. The invention uses software comprising a plurality of modules and neural network elements to store, process and compute, manage, and transmit data. The software elements of the invention also provide for efficient energy use, system control, and communication functions.

### FURTHER OBJECTIVES AND ADVANTAGES OF THE INVENTION

Additional objectives and advantages of the invention are:
1) Relative low cost and ease of implementation compared to complex scientific equipment or combinations or arrays of such equipment;
2) Wide application and access to a rich source of data for farmers;
3) Optimization of crop production and irrigation;
4) Environmental monitoring and data acquisition;
5) Remote collection and access to environmental data over the Internet;
6) Creation of regional and national environmental databases relevant to planners and leaders in making decisions relative to human adaptation to climate-related and other global changes and trends;
7) Compact size, contained in a weather-proof housing, solar-powered, battery-free operation, and ability to incorporate or connect with a variety of devices or sensors as well as monitor and operate other devices depending on the needs of the user;
8) Unique communications function managed by the neural net elements of the control module significantly reducing power demands and increasing the efficiency of communications by efficiently utilizing various frequency bands assigned to adjacent devices in an array of such devices;
9) Highly efficient energy management design enabling very low current demands and thus allowing incorporation of super-capacitor electrical energy storage to obviate the need for batteries, while also eliminating water penetration hazards through case openings or the need for routine operator maintenance to service batteries;
10) Unique sleep/wake cycle process which turns off a single device or an array of devices as required for pre-set times to preserve energy, then waking them to transmit bursts of data at intervals during periods of prolonged darkness or low light thus saving energy and optimizing the collection and transmission of data over the day-night period;
11) Ability to deploy the device as an autonomous single unit or as an array of devices in a network to record and monitor environmental and other conditions in adjacent locations or zones with individual devices in direct or indirect communication with a base-station module, which is in communication with a hand-held data collection device or the Internet via another Ethernet, or cell modem device;
12) Internal data storage and file management capabilities enabling completely independent operation of the devices in remote locations until such time as the operator is able to associate a hand held data collection device with the network and collect the recorded data;
13) Ease of association and security of data is achieved by a unique process, whereby a new ‘adoptable’ powered-up device is automatically associated with a unique base station identifier by passing it very near the base station;
14) An extraordinarily strong radio signal is received by the base device indicating the adjacent data acquisition device is to be added to the network so then the base station stores its unique family data on the device, irrevocably adopting the device and rendering it incapable of joining the network of any other base station with a different identifier;
15) The rounded surfaces of the device enabling it to be brushed aside without locking into passing machinery.

### BRIEF DESCRIPTION OF THE DRAWINGS

FIG. 1 is a perspective view of one embodiment of the invention.

FIG. 2 is a side view of one embodiment of the invention.

FIG. 3A is a front face view of one embodiment of the invention.

FIG. 3B is a cross-sectional side view of the embodiment of FIG. 3A.

FIG. 3C is one embodiment of the invention with a display panel.

FIG. 4A is a side view of one embodiment of the invention.

FIG. 4B is a cross-sectional side view of the embodiment of FIG. 4A.

FIG. 5 is an assembly view of one embodiment of the invention.

FIG. 6 is a front view of the base of one embodiment of the invention.

FIG. 7A is a top view of the base of one embodiment of the invention.

FIG. 7B is a cross-sectional view of the base of FIG. 7A along section BB.

FIG. 8A is a top view of the circuit board of one embodiment of the invention.

FIG. 8B is a back view of the circuit board of FIG. 8A.

FIG. 8C is a first side view of the circuit board of FIG. 8A.

FIG. 8D is a front view of the circuit board of FIG. 8A.

FIG. 8E is a second side view of the circuit board of FIG. 8A.

FIG. 8F is one illustration of the control module of the invention.

FIG. 9A is a diagram of a network of devices in one embodiment of the invention.

FIG. 9B is a diagram of another network of devices in one embodiment of the invention.

FIG. 10 is a schematic diagram of external sensor connections in one embodiment of the invention.

FIG. 11 is a view of LED placement in one embodiment of the invention.

FIG. 12A is a circuit diagram of one embodiment of the invention.

FIG. 12B is a schematic diagram of frequency sub-banding.

FIG. 13 flow diagram of network start-up in one embodiment of the invention.

FIG. 14 is a flow diagram of the sleep/wake cycle of one embodiment of the invention.

FIGS. 15A to 15C is a sequence of views of the device being deflected by farm machinery.

### GENERAL OVERVIEW AND OPERATION OF THE DATA ACQUISITION DEVICE AND NETWORK CONFIGURATION

The device is small, light-weight and robust enough that it can be mounted to a flexible pole, brushed aside by a contacting machine and then spring back in an operating position when the machine passes over it. Power is provided by a power module comprising a set of small solar panels incorporated into the device. These solar panels are oppositely disposed and in an angular orientation to capture solar energy early and late in the day. The solar panels act redundantly to handle cloudy conditions and different orientations of the sun as it moves across the sky during the day. Energy from the solar panels is managed in an optimal way by the control module comprising software elements to charge super capacitors which store the energy in order to supplement the solar panels during energy demand periods that exceed solar panel output. This feature provides for prolonged operational periods of data acquisition and transmission when there is little or no sunlight available for power generation.

The power control functions of the invention allow for much lower power requirements and enable practicable battery-free operation. This gives the device a long life cycle and nearly eliminates the need for human maintenance oversight.

Multiple devices can be deployed in a network arrangement. When deployed in a networked configuration, one of the devices is programmed to be the base station and the remaining devices in the network act as data acquisition devices. Each data acquisition device is able to relay a message from neighbouring devices to the base station in situations where a given device is disabled, unable to reach the base directly by line-of-sight or if the base station is beyond the device's RF transmission range. Each device is able to store its data internally on a memory device and sends a copy of each piece of data it has stored to the base station. In this way should the base station be destroyed or stolen collected data can be recovered from the data acquisition devices. The base station receives and stores data from the data acquisition devices and then re-transmits this data by transmission means such as RF, Ethernet, Internet or cellular network to a data recipient at a home station.

The base station is the administrative control centre for the network. When the device is deployed in a networked configuration, the base station assigns digital identifiers to the other data acquisition devices so that the latter devices are linked irrevocably with the base station network. The network will have a common ID root (the digital identification of the base station) and the data acquisition devices have this root name as an element of the device name. For example, if the base station is called ABC then that will be the root name of the network. Associated data acquisition devices called XYZ and MNO will be adopted by the base station ABC and renamed ABC-XYZ and ABC-MNO. Other deployed data acquisition devices will be named in a similar manner. Once acquired in this manner, the data acquisition devices will not be able to communicate with devices and base stations in other networks even though they may be within transmission range. The base station monitors network operations over each 24 hour period and manages a unique sleep/wake cycle for the data acquisition devices to conserve power during the dusk to dawn or any low-light intensity period. The base station operates to ensure that efficient communications are maintained between the data acquisition devices and the base station as well as between the data acquisition devices themselves. The base station will periodically open channels to each of the data acquisition devices in order to receive the data that has been acquired. The data is then transmitted to the base station for storage, processing and re-transmission to a recipient. Processing may include reformatting the data received from the data acquisition stations into a format optimized for the receiving environment of the home station. The base station also has a maintenance function. For example, if any specific data acquisition device reports an energy storage level that falls below a set voltage level, the base station will invoke a sleep/wake cycle, commanding the energy deficient device to de-activate for a period of time in order to conserve power in the energy storage capacitors. If the base station detects that the voltage drop is consistent across a plurality of data acquisition devices it will command the entire network to de-activate for a period of time ranging from 30 minutes to 2 hours. De-activated devices continue to wake momentarily at a time designated by the base station to communicate data in a burst transmission and then resume sleeping until sufficient energy is absorbed through their solar panels to resume a fully-awake state. For example, the base station will receive data from the data acquisition device at 30 minute intervals as long as voltage levels are stable. If voltage levels rise then the data acquisition device will resume normal full-time operation. If voltage levels continue to fall the base station will command the data acquisition device to sleep for longer periods to preserve power. This allows data capture during dark periods when energy is at its lowest as well as efficient operation during daylight regardless of weather conditions. The operating range between adjacent data acquisition devices and the base station is up to 1500 feet. The power conservation features of the invention are critical to continuing data collection and transmission during seasons where darkness and low light conditions may last for up to 16 hours in a day.

One more feature of the invention is that the data acquisition devices deployed in a network configuration can be readily re-deployed, moved and replaced anywhere within the operating range of the network. The internal communications module operating in each of the devices is able to re-establish communications with the base station and with neighbouring devices without human intervention.

Another feature of the invention is the use of a sub-group selection procedure that is managed by a neural network in the communication module within the base station. The communication module neural network is trained by a first algorithm for achieving power optimized data transmission.

This feature optimizes RF communication between the networked devices, minimizes communications failures and reduces power consumption. This permits use of small-sized solar panels, thus reduces the size and increases the cost effectiveness and utility of the devices.

A further feature of the neural network algorithm in the communications module is the identification and correction of communications faults. If the base station identifies communication faults due to an over population of data acquisition devices communicating over an assigned RF frequency the base station will invoke the sub-group selection procedure which automatically assigns groups or tiers of data acquisition devices to multiple sub-bandwidths around its 915 MHz centre frequency to prevent cross-talk between devices and between adjacent networks. This optimizes communication and reduces transmission failures, reducing energy demands. In addition, communication protocols managed by the communications module in each data acquisition device and the base station ensure that each data acquisition device is aware of and is regularly updated on the presence of any newly established communication links via other data acquisition devices to the base station.

In addition, the design provides for a highly efficient use of solar energy, very low power use during operation, power storage by super capacitors, and the use of intelligent neural network control module technology to enhance RF communications by optimization of sub group selection managed by the control module.

A further feature of the invention is that the device facilitates data collection, data file storage and management, and transmission of diverse data types without human intervention.

Another feature of the invention is that the data acquisition devices are able to autonomously establish alternative communication pathways to and through other near-by devices that are in communication with the base station. This ensures efficient operation of communications within the network and compensates for new obstructions, failed devices within a communication pathway, and removal or destruction of devices. It also enables ready deployment of additional devices.

Yet another feature of the invention is its light, compact and robust construction. The device is about the size of a 60 watt light bulb and can be installed on an appendage such as a flexible pole support for above-ground mounting. This permits installation in a farm field where the pole-mounted device may be in contact with a farm machine, automated irrigation machinery, or a farm animal. It is housed in a rounded plastic weather-proof case and is thus resistant to moisture, dirt and contact with other objects. If installed in a field with moving agricultural machinery, the device can be attached to the flexing pole and be placed above the ultimate crop height to ensure communication connectivity. When brushed aside by a passing pivot irrigator, it will spring back into place and resume connectivity.

The invention can be connected to or incorporate a number of sensors and components such as a light sensor, temperature sensor, a web camera, GPS transceiver, soil moisture sensor, soil pH sensor, irrigation water flow meter and a barometric pressure sensor.

Optionally each device of the invention may have an accelerometer, GPS, diagnostic LEDs and audio-generating devices in a user interface. A remote user may also be able to interface with any of the data acquisition devices through cloud-based software that communicates with the base station, and from there relay commands and new programming to the data acquisition devices.

If a camera is installed on the device it can be physically redirected over a limited range to monitor leaf growth, fruit growth and visual appearance of the crop. For example, the device could be mounted on a gimbal and hand oriented to monitor a specific object. The camera can also be used for infrared sensing and area security, enabling monitoring by a remote user.

### DETAILED DESCRIPTION OF PREFERRED EMBODIMENTS OF THE INVENTION

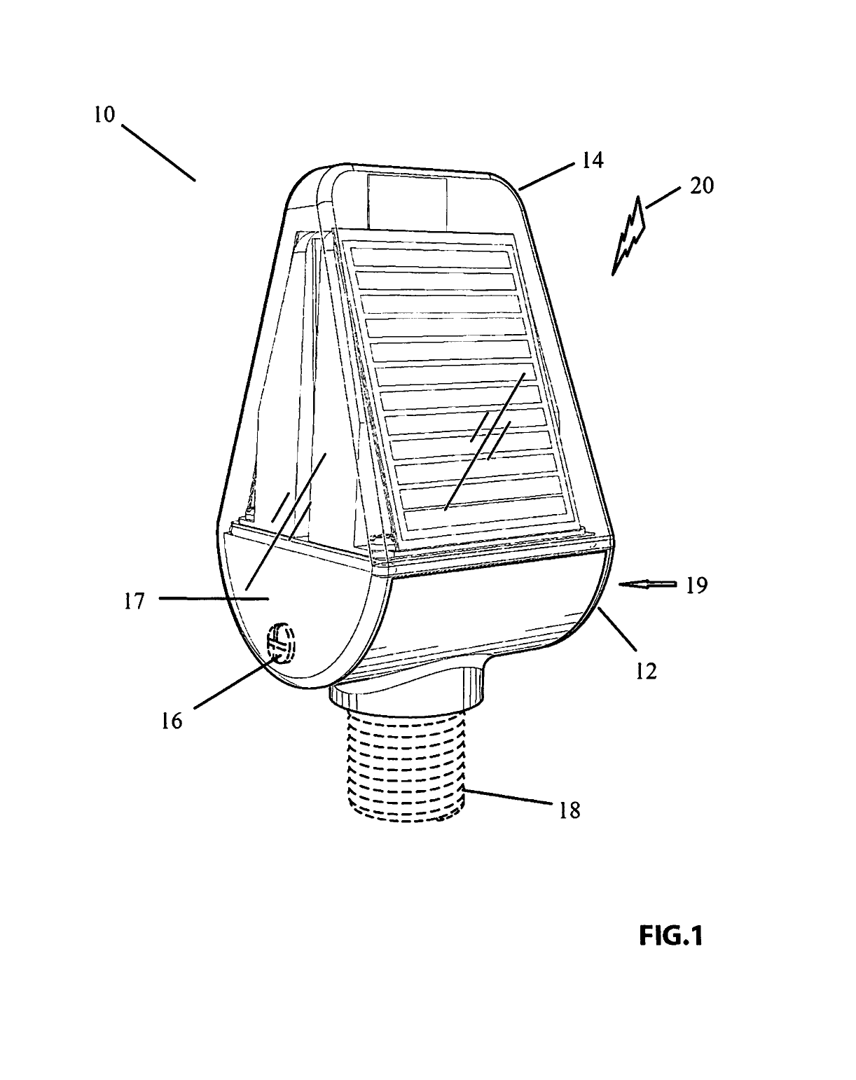

Referring to FIG. 1 there is shown one embodiment of the remote sensing and data acquisition device of the present invention 10. The shape illustrated has generally a wedge profile. Other shapes are possible that meet the objectives of the invention.

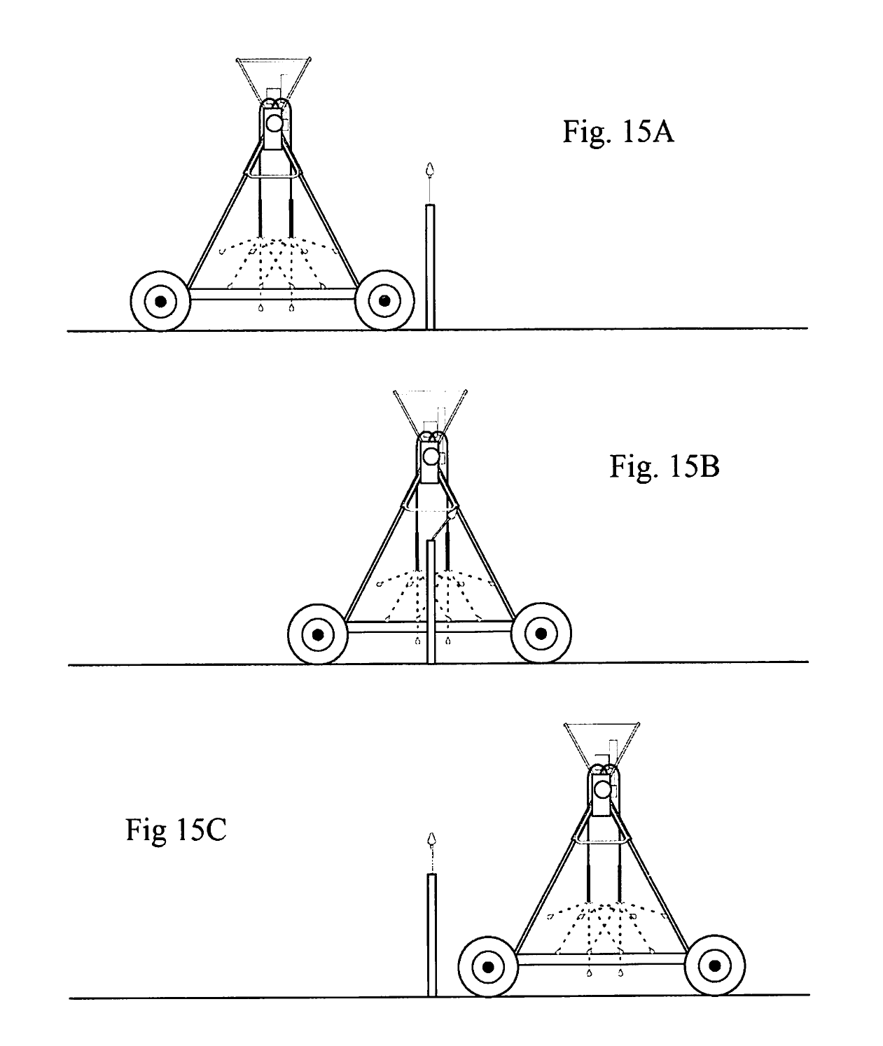

In FIG. 1 the embodiment of the remote sensing device 10 illustrated comprises a base 12 and a transparent shell 14. The shell 14 fits over the base 12 and is fixed in place by a pair of screws 16 on each side 17 and 19 of the base 12. In other embodiments of the invention the shell can be fixed to the base by other moisture proof means such as an adhesive or using a sealed snap-fit. The base further includes a threaded stem 18 so that the base can be attached to an appendage or mounting structure such as a pole if so desired. One example of this is shown in FIGS. 15A to 15C wherein the device is spring mounted to a pole so that accidental contact with a passing machine does not damage the device. The shell 14 is illustrated as transparent to permit solar energy 20 to penetrate through the shell and into the interior of the device 10. Shell transparency also allows an operator to view internal components and annunciating devices that may be visible inside the shell.

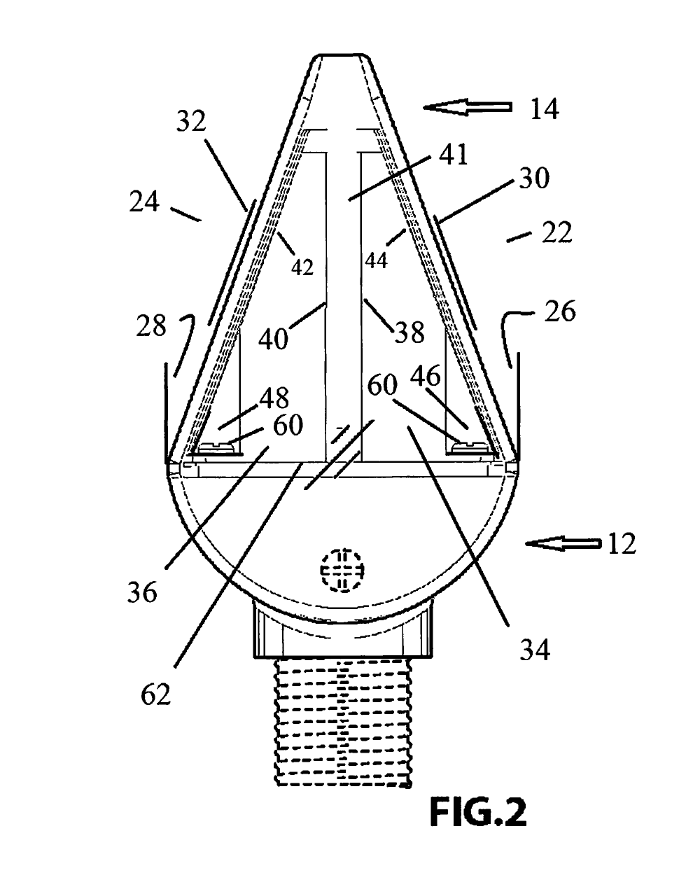

Referring to FIG. 2, and in the embodiment illustrated, the shell 14 has a first face 22 and a second face 24. The first face 22 is angled away from the vertical by a first angle 26 and the second face is angled away from the vertical by a second angle 28. Generally the first angle 26 and the second angle 28 are the same and are optimized for directing solar energy 20 into the interior of the device 10 as the sun moves across the sky during the beginning and end of the day. In another embodiment of the invention the first face 22 and the second face 24 may include a lensing feature 30 and 32 to further intensify solar energy 20 entering the device 10.

Still referring to FIG. 2, under the shell 14 and mounted to the base 12 are shown a first mounting structure 34 and a second mounting structure 36. The mounting structures are mounted vertical back 38 to vertical back 40 with a space 41 between. The front faces 42 and 44 of the mounting structures 34 and 36 are angled 46 and 48. The angle 46 and 48 are generally identical to angles 26 and 28 of the shell 14 first face 22 and second face 24 respectively. The mounting structures 34 and 36 are mounted by mounting means 60 to the top surface 62 of the base 12. Mounting means 60 can include screws, rivets or adhesive means.

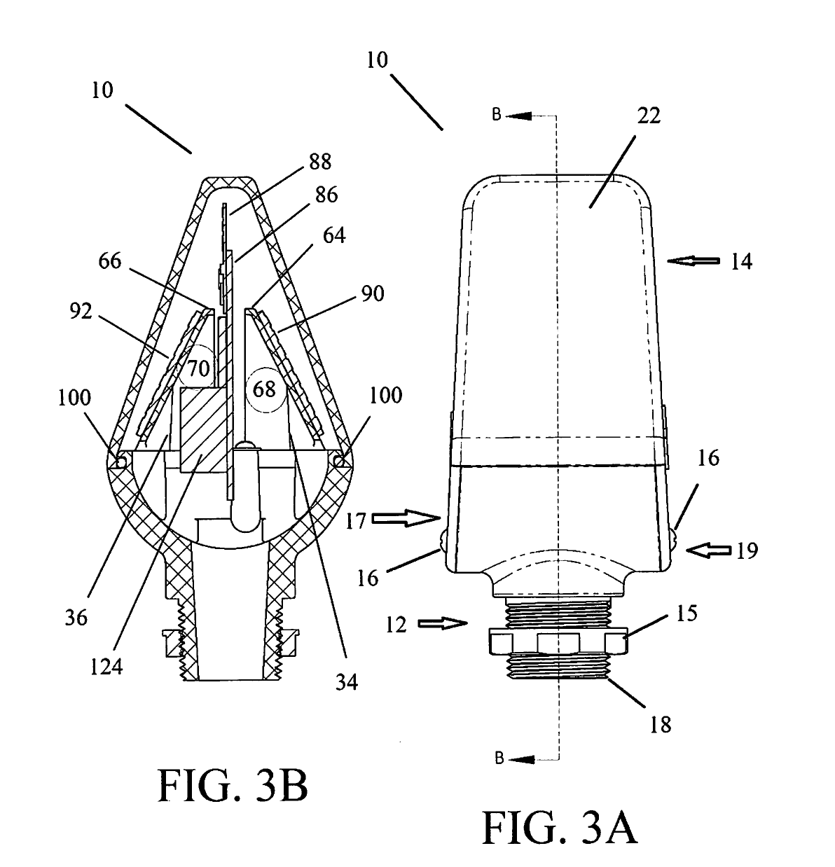

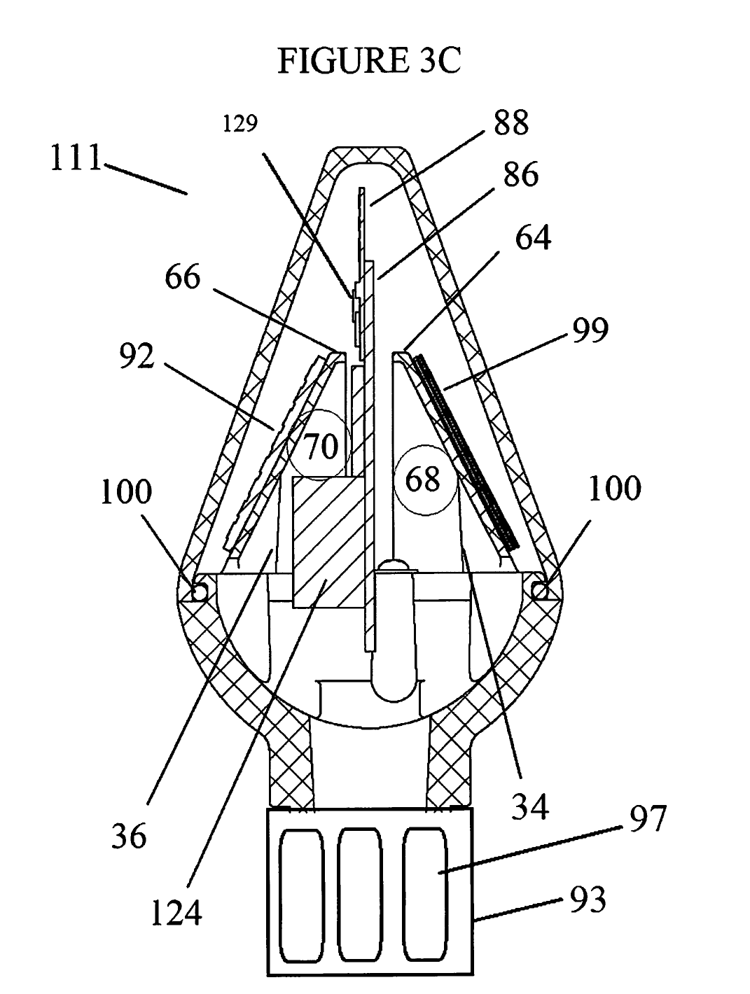

Referring now to FIG. 3A there is shown a front view of face 22 of one embodiment of the invention 10 and a sectional side view of the same embodiment along section line B-B in FIG. 3B. Side 17 faces the viewer in FIG. 3B. FIG. 3A illustrates face 22 of transparent shell 14 mounted to base 12 by mounting screws 16 in each of left side 17 and right side 19. Threaded mounting stem 18 is shows with mounting screw 15 for mounting the device 10 to a mounting post.

The exterior surfaces 64 and 66 of the mounting structures 34 and 36 create an internal space 68 and 70 behind each mounting structure. When combined with space 41 [FIG. 2] these internal spaces 68 and 70 allow the mounting of a printed circuit board 86. Protruding from the top edge of the printed circuit board 86 is an antenna structure 88 which is more fully described below.

Mounted to the exterior surfaces 64 and 66 of mounting structures 34 and 36 are a first photo-voltaic cell 90 and a second photo-voltaic cell 92. Combined these cells collect solar energy and convert it to electric power to power the remote sensing device as more fully detailed below.

Referring to FIG. 3B and FIG. 3C there is between the shell 14 and the base 12 a water proof and dirt proof sealing ring 100. The internal spaces 68 and 70 are used to accommodate components of the printed circuit board 86 such as the super capacitor 124.

Referring to FIG. 3C and in another embodiment of the invention there is illustrated a hand-held device 111 operable by a user to communicate with a deployed remote sensing device. The hand-held device 111 is generally the same as a data acquisition device as illustrated in FIGS. 3A and 3B except that there is one solar cell 92 mounted to exterior surface 66. Additionally, since the hand-held device includes a grip 93 including batteries 97 it may not have a super capacitor to store energy. On exterior surface 64 there is a display panel 99 of an LED or LCD type. The display panel displays a variety of operational parameters to the user upon receiving a signal from the user. Any deployed data acquisition device, when queried by the user using the hand-held device will download a copy of its stored data to the hand-held device. The user is also able to input programming to the data acquisition device or to a network of configured devices. An accelerometer 129 is installed on the circuit board which is used to permit the user to activate software stored on the hand held device by user gesture such as a tap and communicate with any data acquisition device or network of devices in the field.

The operator taps once on the transparent case of the hand-held device above the display screen to start a software program which opens a menu on the display screen allowing further communication with an adjacent data acquisition device or nearby network. Further single taps or predetermined sequences of taps allow the user to scroll through menu options. The operator can then exercise a double tap on the case to select a specific option. For example, the user may be able to walk in a farm field with the hand-held device to a data acquisition device to view its acquired data or download data from the entire array of devices through the accessed device into the hand-held device. Once the user returns to the home station, data collected into the hand-held device can be downloaded into a personal computer and into the Internet for onward transmission. Another option can be used by the user to check the ability of a newly installed data acquisition device to communicate with the base station by a series of taps on the casing to instruct an adjacent data acquisition device to transmit data to the base station and then verify that such transmission is happening correctly.

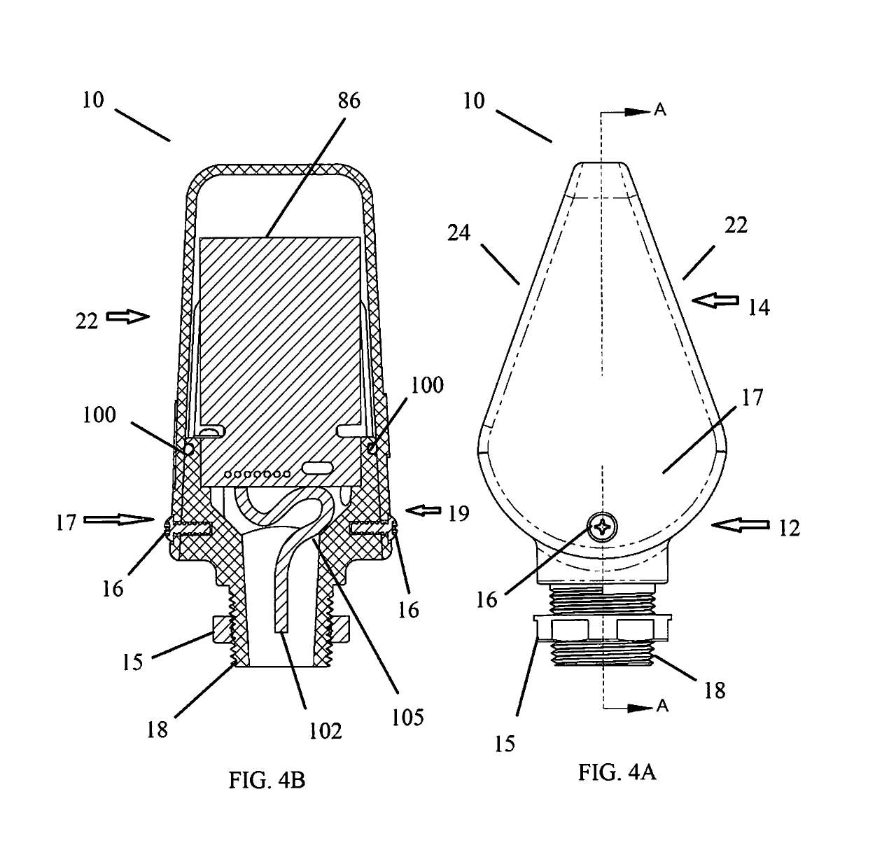

Referring to FIG. 4A and FIG. 4B there is shown in FIG. 4A a side 17 view of one embodiment of the invention 10. In FIG. 4B there is shown a cross-sectional side view of the invention 10 through section line A-A in FIG. 4A. Face 22 faces the viewer in FIG. 4B. FIG. 4A illustrates face 22 and face 24 of transparent shell 14 mounted to base 12 by mounting screws 16 in each of left side 17 and right side 19. Threaded mounting stem 18 is shows with mounting screw 15 for mounting the device 10 to a mounting post.

FIG. 4B illustrates a cross-sectional side view through section line A-A and shows the transparent shell 14 mounted to the base 12 by screws 16. Between the shell 14 and the base 12 is a water proof and dirt proof sealing ring 100. Within the shell 12 is found circuit board 86 and connecting cable 102 that connects the circuit board to external sensors and exists through the base 12 by way of an environmentally secure channel 105 through threaded stem 18. Mounting nut 15 is also shown.

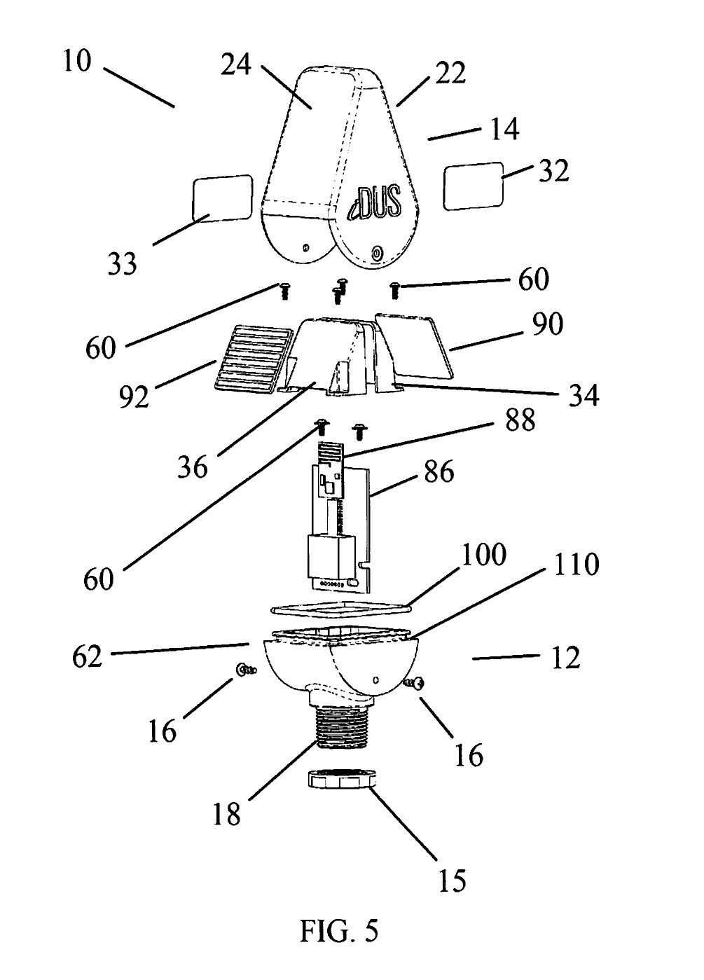

Now referring to FIG. 5, there is shown an assembly diagram of one embodiment of the invention 10. The transparent shell 14 including faces 22 and 24 is mounted to the base 12 by way mounting screws 16 in each side of the base. A solar energy intensifying lens 32 and 33 may be fixed over each of the faces 22 and 24. Under the shell 14 is mounting structure 34 and 36 which are mounted to the top 62 of the base 12 by screws 60. Solar voltaic panels 90 and 92 are mounted to the mounting structures 34 and 36 respectively by adhesive or other means. Circuit board 86 has antennae 88 as one of its mounted components illustrated as mounted to the base 12. The circuit board is disposed between the two mounting structures and internal spaces under the exterior surface of each mounting structure accommodate components of the circuit board. Between the shell 14 and the base 12 is a moisture and dirt proof sealing ring 100 which is disposed within groove 110. Threaded stem 18 depends from base 12 and includes a mounting ring 15.

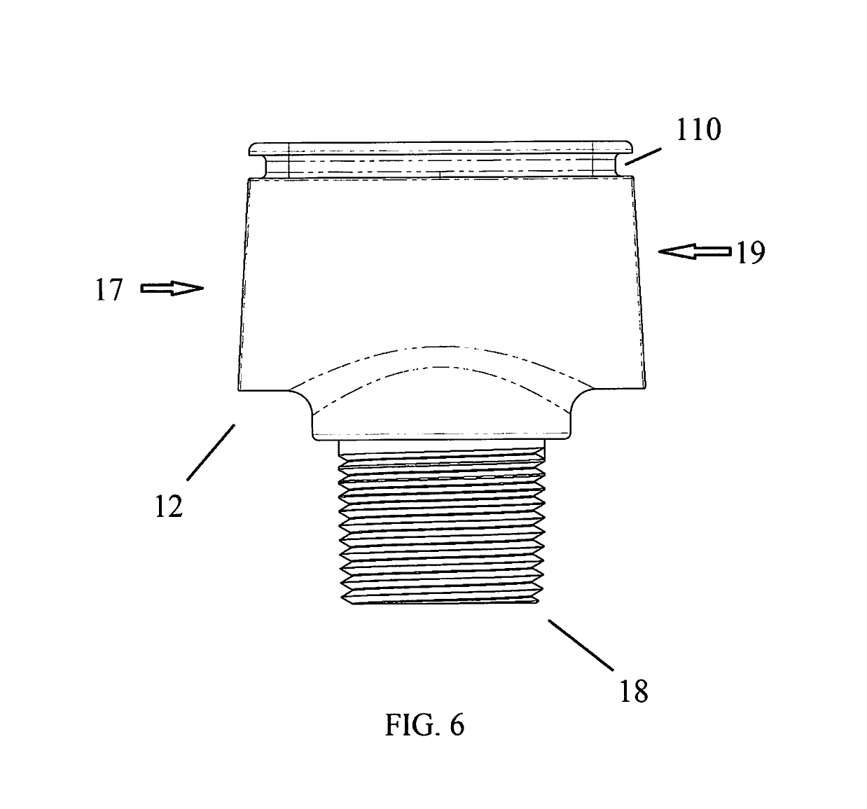

Referring to FIG. 6 there is shown a front view of the base 12 comprising a left side 17 and a right side 19. The groove 110 receives the sealing ring 100 as previously described and illustrated. Threaded stem 18 depends from the base 12.

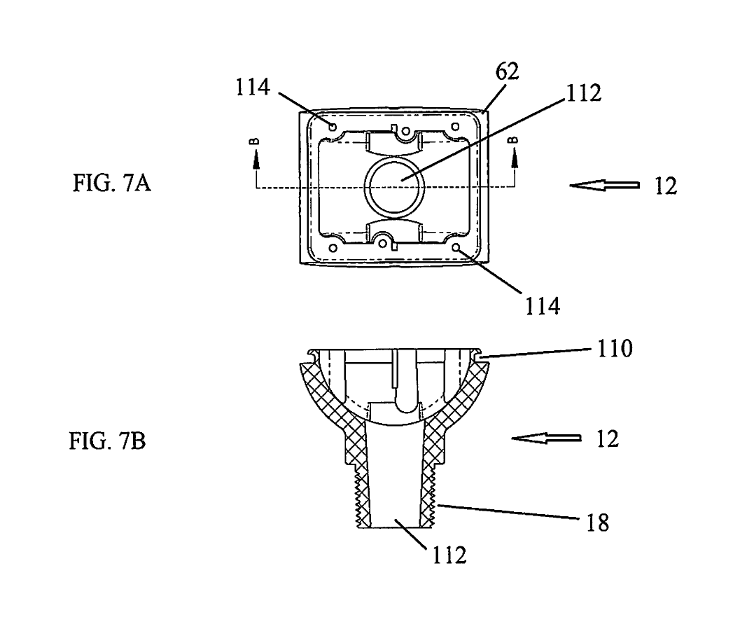

Referring to FIG. 7A and FIG. 7B, there is shown in FIG. 7A a top view of the base 12 and in FIG. 7B there is shown a cross-sectional side view of the base along sectional line B-B. FIG. 7A illustrates the base 12 having a central passage 112 extending through the stem 18 to accommodate the connection cable 102 illustrated in FIG. 4A. The top surface 62 of the base includes holes 114 for receiving mounting screws 60. Groove 110 circumscribing the top of the base receives the sealing ring 100. In FIG. 7B the base is shown in cross section with the central passage 112 extending through the stem 18 into the top portion of the base.

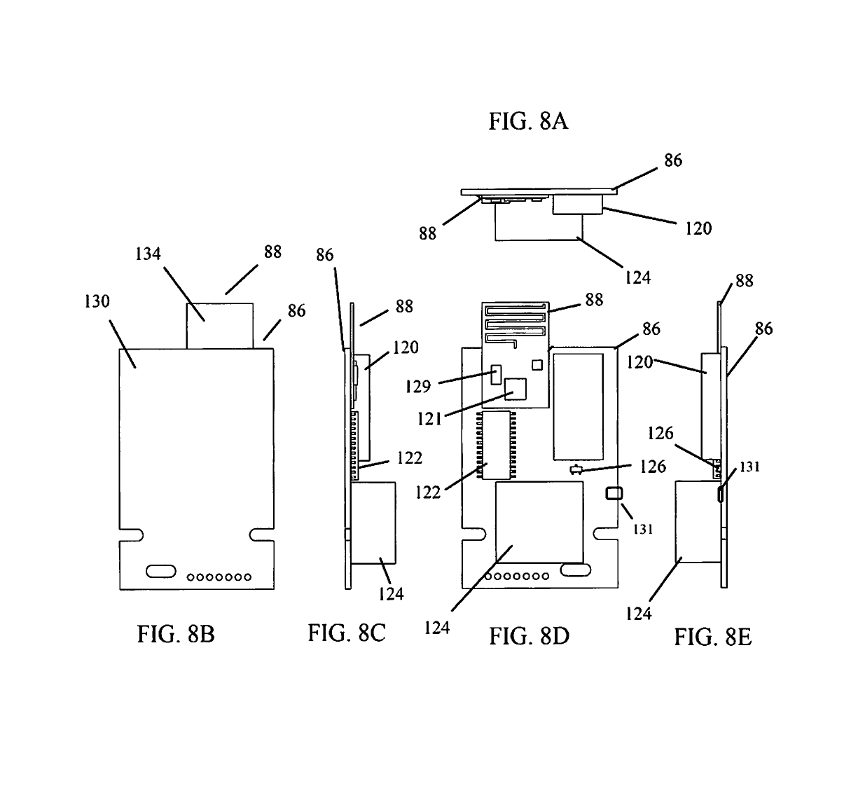

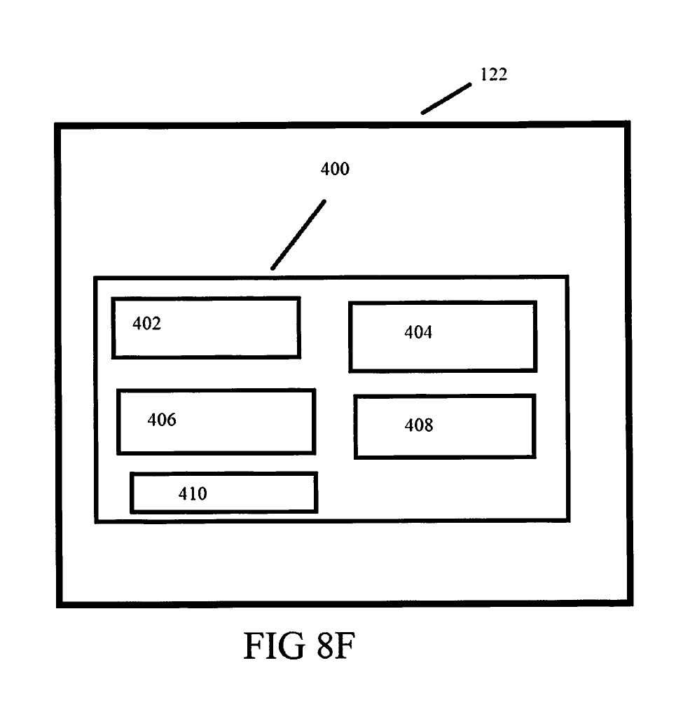

Referring to FIG. 8A to FIG. 8E there are illustrated a variety of views of one embodiment of the printed circuit board 86 of the invention which is mounted under the shell 14 to the base 12 and between the two mounting structures 34 and 36 as previously described and illustrated. FIG. 8A is a top view. FIG. 8B is a back view, FIG. 8C is a left side view, FIG. 8D is a front view and FIG. 8E is a right side view. FIG. 8A shows the following components: optional GPS device 120, super capacitor for energy storage 124 and antennae 88. FIG. 8B illustrates the back 130 of the circuit board 86 and the back 134 of the antennae 88. FIG. 8C is a left side view of the circuit board 86 illustrating the antennae 88, the microprocessor 122 and the super capacitor 124. FIG. 8D illustrates a front view of the circuit board 86 comprising antenna 88, microprocessor 122, optional GPS device 120, super capacitor 124, thermal sensor 126 and optional camera 131. FIG. 8E illustrates a right side of the circuit board 86 mounting antenna 88, optional GPS device 120, super capacitor 124, thermal sensor 126 and optional camera 131. The antenna in one embodiment of the invention is an RF antenna. The optional GPS device 120 is mounted to the board so that the location of the remote sensing device 10 can be determined relative to a base station and to other remote sensing devices that may be connected in a remote sensing grid as more fully explained below. The optional camera 131 can be a micro camera chip and can be mounted to the printed circuit board to capture images through the side of transparent cover 14. A microprocessor 122 is mounted to the printed circuit board in order to control the functions of the remote sensing device 10 and to execute commands receive remotely by way of the antennae 88 from a base station. The microprocessor 122 also controls the power functions of the remote sensing device including control of the super capacitor energy storage device 124. A temperature sensor 126 is also mounted to the printed circuit board 86 to measure ambient temperature. Other sensors external to the remote sensing device 10 can be connected by connection cable 102 and received by the microprocessor. These are more fully explained below.

Referring to FIG. 8F there is shown a drawing representing a control module 400 of one embodiment of the invention. The control module 400 resides within the microprocessor 122 and comprises sub-modules for communications 402, power management 404, data processing 406, sensor management 408 and optional GPS control 410. Other control elements can be programmed into the control module as desired.

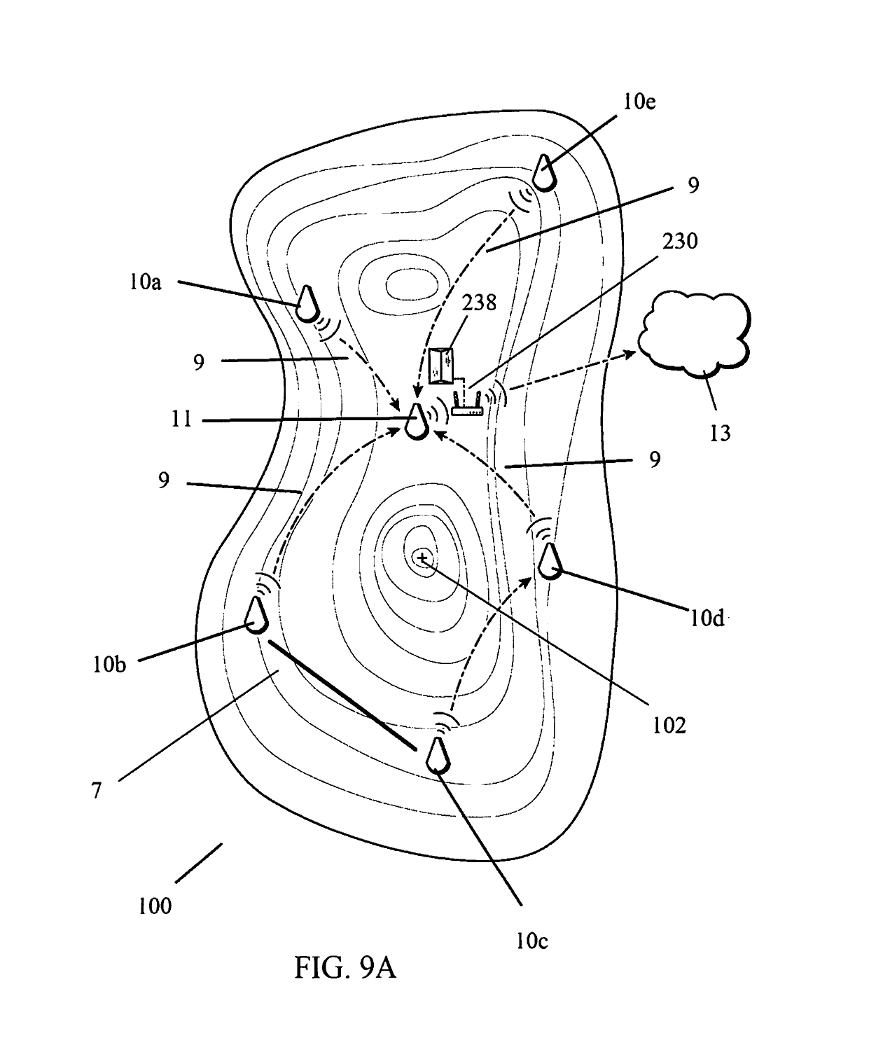

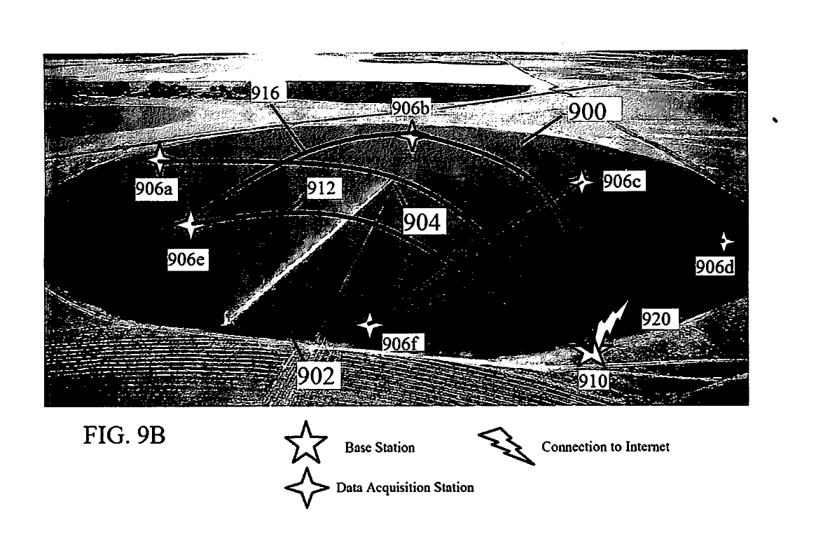

Referring to FIG. 9A, the device can be networked into an array to cover a large geographical area 100 that may have a variety of different environmental properties. Each individual networked device 10a to 10e acts as a data acquisition device and collects a variety of environmental data from on-board and external sensors. One of the devices 11 is configured to act as a base station. On-board sensors may include a temperature sensor as shown in FIG. 8D items 126.

FIG. 9B illustrates a second embodiment of an array namely a circular plot of land 900 irrigated by an irrigation system 902 that rotates around an axis 904. A network of data acquisition devices 906a to 906f is installed over the plot 900. A base station 910 controls the operation of the data acquisition devices. The maximum line-of-sight RF communication distance between each data acquisition device and between each device and the base station is 1500 feet. The data acquisition devices communicate 912 by RF with the base station 910 and with each other 916 in order to relay data to the base station. The base station communicates 920 with a home station by RF or Ethernet or cellular network. The remote station can be linked to the Internet through a wired or wireless modem.

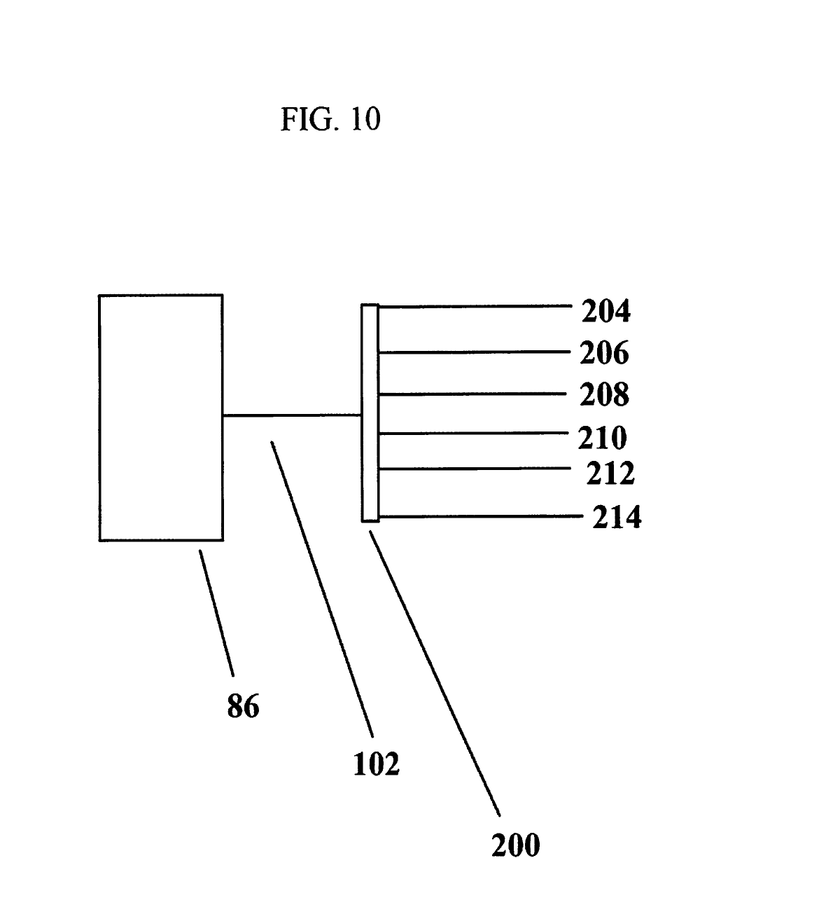

Referring to FIG. 10, external sensors may include: a camera 204, a light sensor 206, a soil pH sensor 208, a soil moisture sensor 210, irrigation flow sensor 212, irrigation pump operation sensor 214 and any other sensor to collect relevant data. These external devices can be connected to a connection bus 200 which in turn is connected by cable 102 to the circuit board 86. Operation of the sensor array is controlled by the sensor module within the control module.

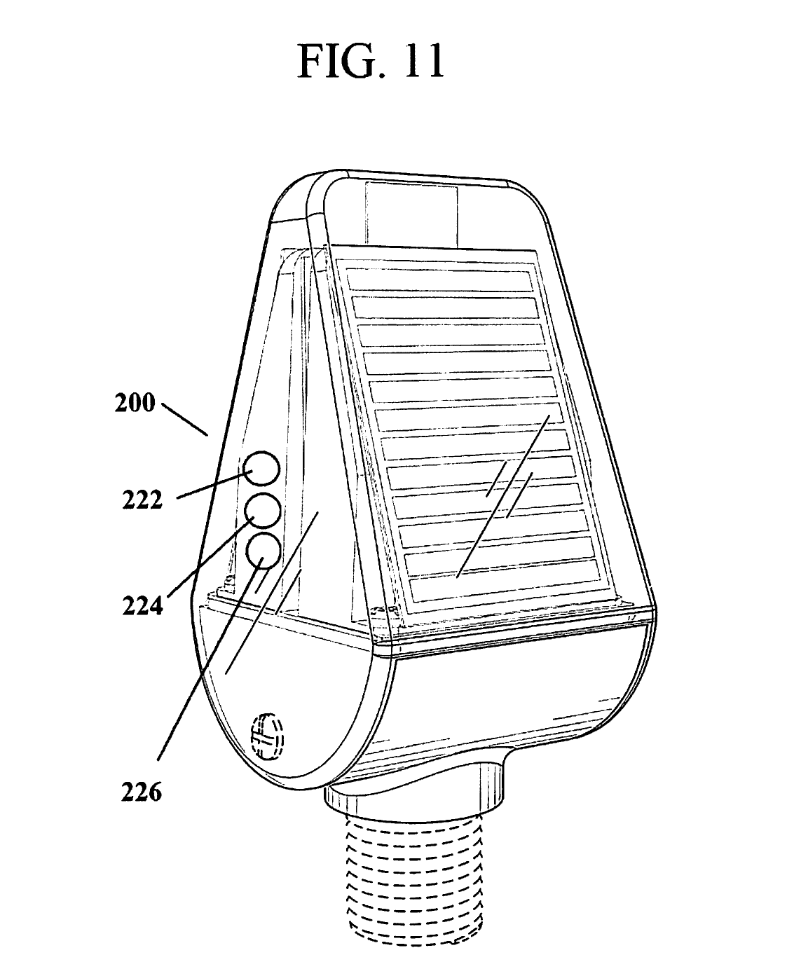

Referring to FIG. 11, diagnostic LEDs 220 can also be installed as part of a user interface. For example the LEDs may be green 222, orange 224 and red 226 to indicate operational status or they may blink in a pre-programmed manner to indicate a specific condition or fault. The LEDs can be programmed to identify a fault or condition in an individual networked device or in the base station.

Referring back to FIG. 9A, the data collected by each data acquisition device 10a to 10f is stored in an on-board memory device as shown in FIG. 8D, item 121. One of the network data acquisition devices will be configured to be a base station 11. The base station 11 will communicate 9 with the other networked devices either directly, from base station to device, or by a data relay 7 from a first device 10c to a second device 10b and then to the base station 11. The base station will periodically poll each data acquisition device 10a to 10f individually by an RF signal 9 and the queried device will transmit a copy of its data to the base station for storage and processing. A copy of the data always remains on the memory storage device for redundancy. While RF communications appears to be a simple means of implementing the network communications, other means can be used to communicate between devices and the base station such as a cellular network or a wired network.

In the networked embodiment illustrated in FIG. 9A, the base station 11 is connected to the Internet 13 by an Ethernet or modem device 230.

Power is provided to the individual device 10 and the base station 11 by the dual solar panels 90 and 92 shown in FIG. 3B. Solar energy reaching the solar panels can be enhanced by magnifying windows 30 and 32. Power is managed by the power module programmed on the electronic control board microprocessor 122.

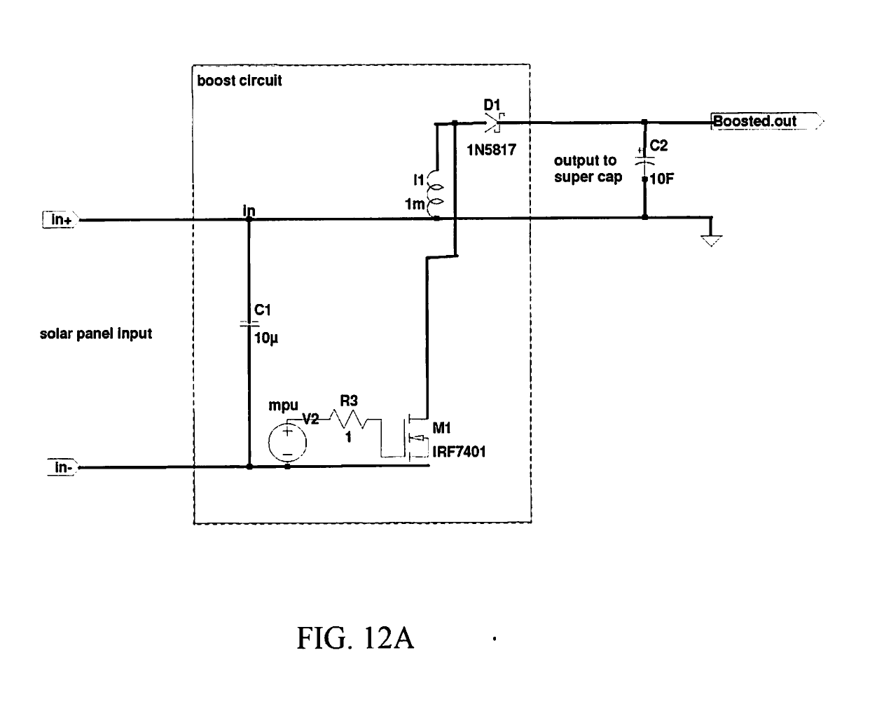

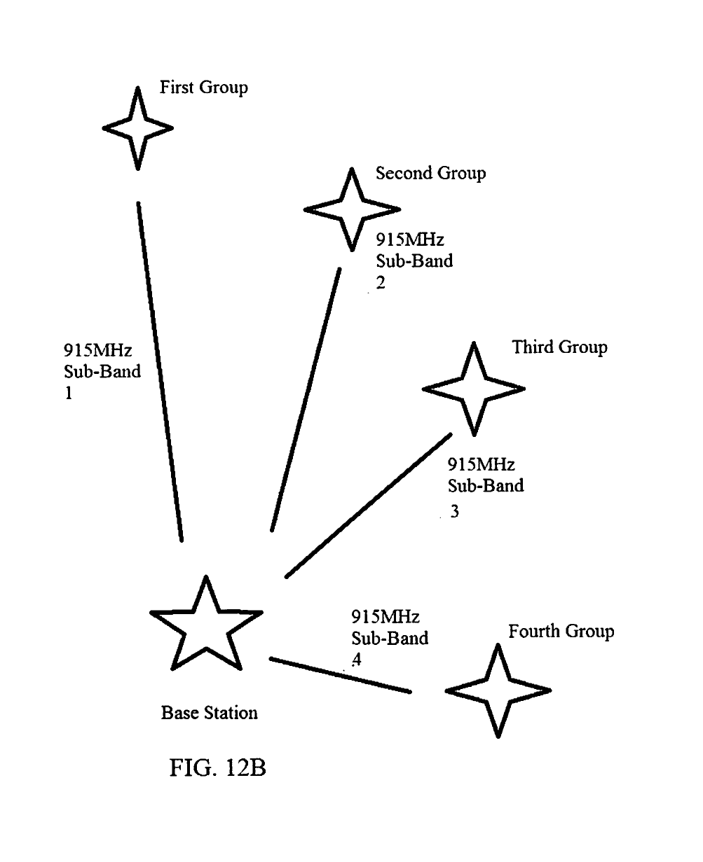

There is an advanced photo-voltaic cell to super-capacitor 124 circuit illustrated in circuit diagram FIG. 12 which optimizes the flow of energy from photo-voltaic cells to the super-capacitor. Generally, the output of the solar photo-voltaic cells is sufficient to power the device however; energy is stored in the super-capacitors 124 for high power demands. The output of the solar panels is optimized along with the charge rate of the super-capacitors by the power module. The super-capacitors also provide pulsed energy bursts to operate equipment at times when energy requirements exceed the output of the solar panel, such as during low light conditions.

The neural network-enabled control module is programmed into the microprocessor 122. It provides for the efficient acquisition, storage, processing and transmission of environmental data from the on-board and remotely connected sensors. The control module using its sub-modules as illustrated in FIG. 8F manages the collection and transmission of data including light (time of dawn and dusk), temperature, optionally a position via the optional GPS control module, visual data from the on-board camera, a motion sensor, soil moisture sensor, soil pH sensor, and also soil chemical properties, irrigation pump flow rates, pump and valve operations and other relevant data as required.

Referring back to FIG. 9A, data acquisition devices deployed in the illustrated network configuration may not be able to communicate directly with another data acquisition device or with the base station by line of sight due to intervening obstructions such as hill top 102. In this case, communication is facilitated by individual devices having the capability to recognize neighbouring units and utilize those units to relay data to the base station where it is stored and transmitted. The stored data now also contains a record of the new pathway.

The network of data acquisition devices is configured by the unique communication sub-module programmed into the control module of each device and in the base station unit to optimize communication between devices and provide for regular checks of connectivity. The base station assigns and records an identifier to each data acquisition device. This allows an operator to relate the data received from a given data acquisition device to its location, specific crop or application. Each of the data acquisition devices is regularly polled at 15 minute intervals by adjacent data acquisition devices in the network so that it may keep track of its communication with adjacent units and the communication pathway by which data is relayed either directly to the base station or by means of an adjacent device to the base station. Thus if a unit is disabled, alternate communication pathways are always available to each device. Data acquisition device relationships are kept updated so that an alternate path can be created to report data. In addition, the ability of the data acquisition devices to establish fresh communication pathways to relay data back to the base station facilitates deployment of the invention over large areas that include natural and human made obstacles. In addition, if one data acquisition device is damaged and can no longer function as a communications node, the adjacent data acquisition devices can create data pathways that circumvent the damaged device.

As the network increases in size, the volume of radio traffic increases nearly exponentially due to messages being re-transmitted inside the network instead of being sent directly to the base station. With more devices conducting their communication bursts near the same time and often in adjacent pathways, messages may overlap and become corrupted necessitating re-transmissions and greatly increasing the time it takes to gather the data.

To improve efficiency, the base station charts all data pathways and uses a neural network pathway analysis routine within the communications module to learn and relearn which of the charted pathways are the most efficient, based on the pathway's ability to convey uncorrupted data.

Referring to FIG. 12B, the neural net elements of the communications module in the base station enable a “frequency sub-banding” capability. This intelligently assigns varying frequency sub-bands to neural-net selected groups devices within a networked configuration depending on their current routing pathways. The neural net element within the communications module enables concurrent communications within a large network of these devices thereby reducing communication times and power demands. This further enables the small size and cost effectiveness of the devices. When corrupted data starts appearing, the base station groups devices into sub-network groups along optimal pathways and assigns those groups of devices a sub-frequency band around the system's 915 MHz centre frequency range [915 MHz Sub-Band 1 to 4]. Transmitting concurrently on different frequencies eliminates data corruption and thus fewer re-transmissions are needed along each pathway, allowing the base station to rapidly switch between each sub-network's frequency and collect its messages. This results in significant power savings.

Prior to installation of the network each data acquisition device is passed so near the operating base station that the base station detects the strongest possible radio signal emitted by the data acquisition device. Once the signal is detected, the base station uses this signal to initiate an identification sequence. It reads and records the unique identifier of the data acquisition device and then transfers its own unique base station identifier to it. The result is a combined base station/data acquisition device identifier which is irrevocably stored in the data acquisition device's memory. This irrevocably “adopts” each data acquisition device to the base station and identifies the entire network of data acquisition devices as controlled by the base station. This is a security feature that prevents a data acquisition device of one network from sharing data with an adjacent network or a base station from communicating with data acquisition devices not a member of its network family. Thus the data is secure and communication is confined to exchanges between devices within the network.

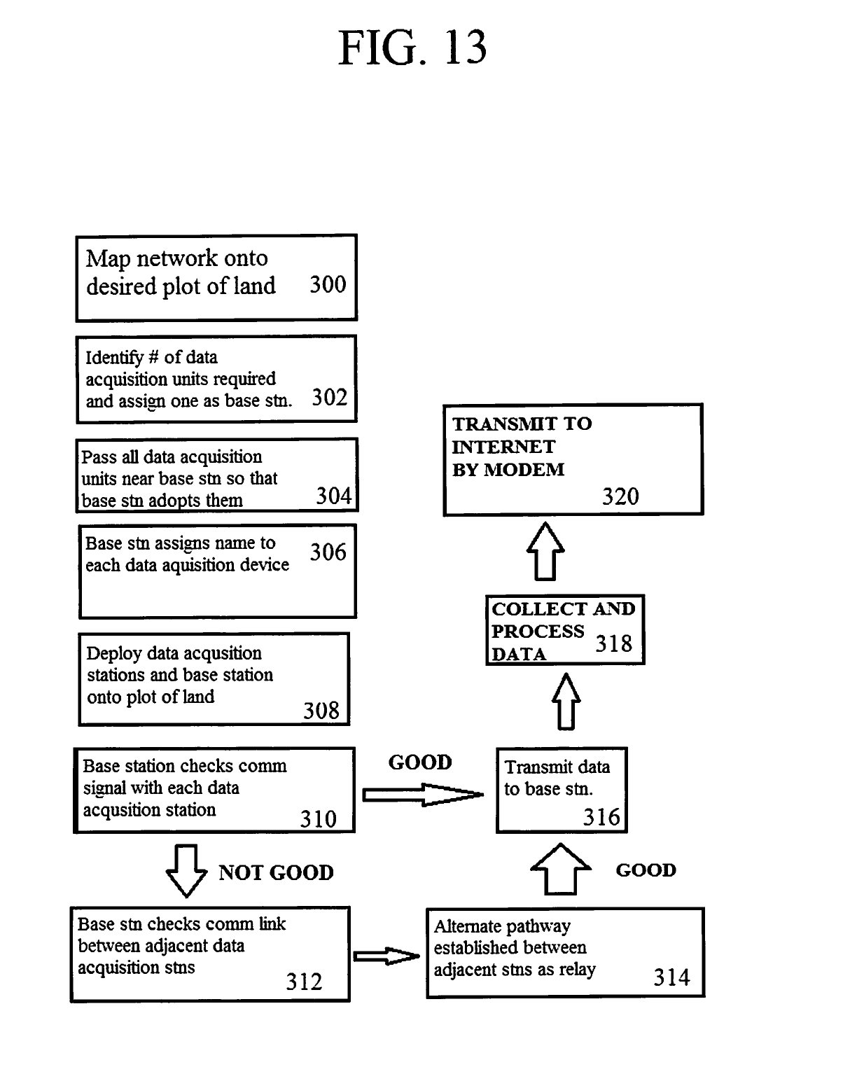

Referring to FIG. 9A and FIG. 13 and in operation, the base station 11 administrates the operation of the network 100 and records the identifiers of each of the individual data acquisition devices. For example, if the base station has a digital identifier as “11” and the data acquisition stations have respective identifiers “10a” to “10e” then the adoption process will identify each data acquisition device controlled by base station 11 as “11/10a” to “11/10e” and the network will be known as network “11”. The adoption process codifies the relational position of each data acquisition device within the network; coordinates how individual data acquisition devices join the network and communicate with the base station and with each other; handle routing of data received from each data acquisition device in the network; and, communicate externally with the Internet 13. In one embodiment of the invention, an installation start-up sequence might appear as shown in FIG. 13:
Step 300—map network onto desired plot of land.
Step 302—identify the number of data acquisition devices required for the plot of land and assign one of the devices as a base station.
Step 304—turn on all devices and pass each data acquisition device near the base station whereupon the base station detects a RF signal which will identify the data acquisition device as an “adopted” device into the base station's network.
Step 306—provide an identifying digital name to each data acquisition device in the network 11/10a to 11/10f.
Step 308—deploy the base station and the data acquisition devices onto the plot of land.
Step 310—base station checks communication links between it and all data acquisition devices in the network.
Step 316—if the communications links are good then the base station can receive data from the data acquisition devices.
Step 318—base station collects, stores and processes data.
Step 320—base station transmits data to Internet.
Step 312—if connectivity is not good then the base station will check connectivity between adjacent data acquisition devices;
Step 314—data acquisition devices will establish a relay between adjacent data acquisition devices to communicate with base station;
Step 316—data is transmitted to the base station;
Step 320—data is transmitted to the Internet.

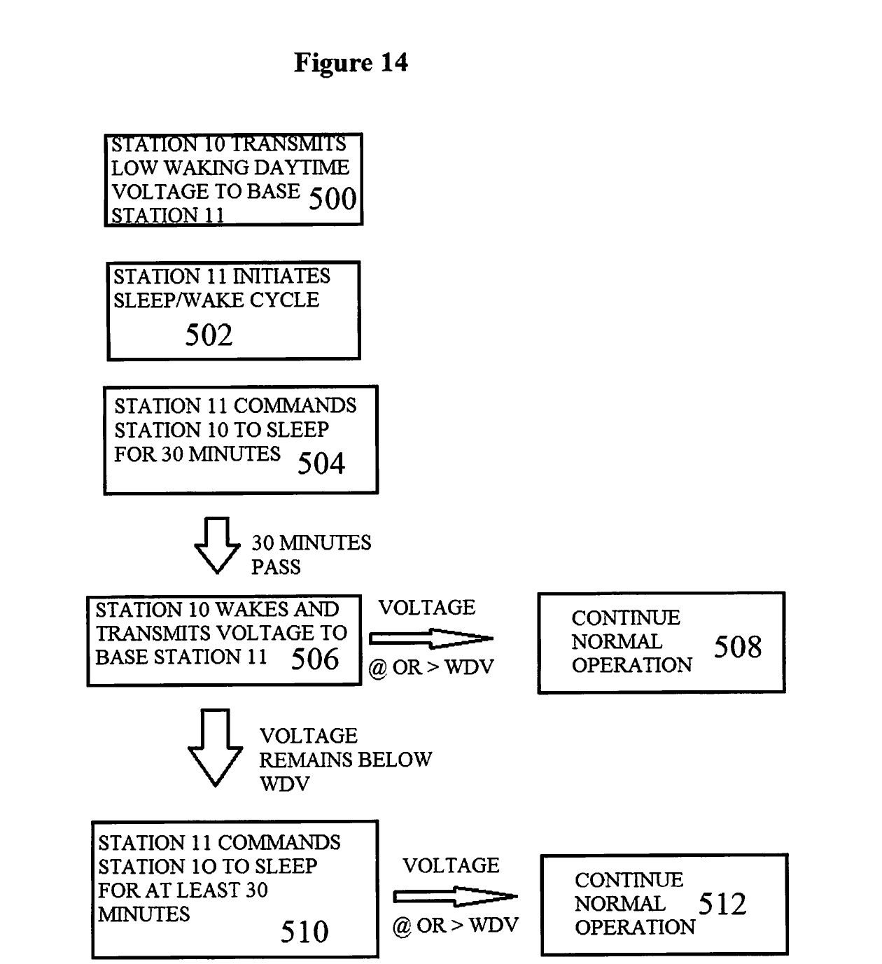

Referring to FIG. 14, an additional characteristic of the invention when deployed in a network array is a “sleep/wake” cycle. This cycle is intelligently managed by the base station. The cycle facilitates the conservation of energy and allows the network to continue collecting and transmitting data during prolonged dark or low light conditions when there is no or little current generated by the photo-voltaic cells. A single data acquisition device will only use a tiny portion of its stored energy for a transmission. When the energy level stored in any device in the network drops below a set ‘waking daytime voltage’ the base station commands the device to cease function and “sleep” for a period of 30 minutes. Once the acquisition device “wakes” it will transmit a pulse of data to the base station and if energy is still below the waking daytime voltage will resume sleeping until the next assigned wake time. If other devices in the network continue to fall in voltage, all devices in the network are commanded by the base station to “sleep” for an assigned sleep period. The assigned sleep period can lengthen to a maximum of 2 hours depending on the energy depletion in the network. The base station monitors the data acquisition devices and manages their sleep cycle and its duration to optimize power consumption while still facilitating regular data gathering by all the units in the array during non-light periods. The power management features of the invention allows the network to continue data gathering, transmission and storage for prolonged periods of low light or darkness. Fully charged devices are capable of conducting the sleep/wake cycle for up to 36 hours.

Referring to FIG. 14, the sleep/wake cycle is shown as comprising the following steps:

Step 500—a data acquisition device transmits a low waking day voltage signal to base station 11.

Step 502—base station 11 initiates a sleep/wake cycle.

Step 504—base station II transmits a sleep signal to device 10 to sleep for 30 minutes.

Step 506—after 30 minutes device 10 awakes and transmits data by burst RF transmission and voltage level to the base station.

Step 508—if the system voltage of device 10 is equal to or greater than the waking daytime voltage then the device 10 continues fully awake operation.

Step 510—if the system voltage of device 10 is not at the waking daytime voltage, and if its voltage has further decreased the base station 11 will send a signal to the device 10 to sleep for at least 30 minutes so that the device charges.

Step 512—after the sleep time interval passes, device 10 will awake, and transmit data and voltage level to the base station. If voltage has increased to waking daytime voltage, then device 10 continues fully awake operation.

Referring to FIGS. 15A to 15C the device can be installed on a flexing pole to allow the unimpeded passage of farm machinery.

While this description has been primarily written to cover the collection of environmental data for agricultural purposes, there are many other uses for this device. The invention is equally suited for any setting where environmental data is recorded for scientific and biological research, safety and security applications, monitoring of hazardous sites and industrial applications such as plants, pipelines and electrical grids, factories and processing operations. With sunlight or artificial forms of illumination, the invention can also be deployed to monitor environmental conditions and environmental quality in buildings such as greenhouses, animal barns, hatcheries and fish farming operations or in any situation where the health of humans and animals requires monitoring and control. Finally, the invention can be deployed in remote locations for scientific, weather data, or other data collection purposes where there it is difficult to send a person to collect the same data. Remote deployment may include hydroelectric engineering sites, water gauging networks, tsunami warning locations, unstable terrain and landslide situations, highway snow safety structures and isolated sections of pipelines and power grids. The data acquisition devices can be used to detect emergencies and maintenance requirements.

What is claimed is:

1. A fully integrated and autonomous remote sensing device comprising:
a. an environmentally secure body defining a transparent exterior surface and an interior space for housing;
b. a device control module;
c. a sensor module for gathering a plurality of environmental data;
d. a battery-free power module comprising:
i. a pair of oppositely disposed solar panels for east-west orientation;
ii. at least one super capacitor for power storage connected to said pair of oppositely disposed solar panels; and,
e. a communication module for communicating said plurality of environmental data to a receiving station.

2. The device of claim 1 further comprising a GPS module for position location.

3. The device of claim 1 wherein said communication module comprises a neural network trained by a first algorithm for achieving power optimized data transmission.

4. The device of claim 1 wherein the sensor module comprises an internal sensor suite disposed within said interior space and an external sensor suite disposed outside of the interior space.

5. The device of claim 1 wherein the control module comprises a microprocessor, a data storage device for storing the plurality of data and a software module for processing the plurality of environmental data.

6. The device of claim 3 wherein the communication module further comprises a radio frequency transmitter and receiver for receiving and transmitting the plurality of environmental data and programming.

7. The device of claim 5 wherein said software module includes a sleep/wake cycle sub-routine for optimized power consumption.

8. A remote sensing system comprising:
a. at least one fully integrated and autonomous data acquisition device having a predetermined data transmission range and deployed in a geographical area of interest for gathering a plurality of environmental data; and,
b. a hand-held station disposed within said predetermined data transmission range for receiving said plurality of environmental data and for transmitting programming to said at least one data acquisition device.

9. The system of claim 8 wherein said held-held station comprises an environmentally secure body for housing at least:
a. a control module comprising: a microprocessor, a data storage device for storing the plurality of environmental data and a software module comprising a plurality of programs;
b. means for detecting a user gesture for executing a specific one of said plurality of programs;
c. a power module comprising an at least one solar panel for charging an at least one battery;
d. a display screen for displaying at least one operating parameter to said user; and,
e. a communications module for communicating with the at least one data acquisition device.

10. The system of claim 9 wherein the user gesture is at least one finger tap on said environmentally secure body.

11. The system of claim 10 wherein said means for detecting the user gesture is an accelerometer.

12. The system of claim 11 wherein upon a specific sequence of said at least one finger taps said accelerometer generates a signal to execute said specific one of the plurality of software programs resulting in a display of said at least one operating parameter on said display screen.

13. A remote sensing system comprising:
a. a plurality of fully integrated and autonomous data acquisition devices deployed in at least one networked configuration over a geographical area of interest for gathering a plurality of environmental data;
b. an autonomous and fully integrated base station disposed outside of said at least one networked configuration and in communication with each data acquisition device of the at least one networked configuration, wherein said base station is disposed to receive and process said plurality of environmental data for further transmission to a home station by cloud computing over a computer network; and,
c. wherein said home station is operated by a user for transmitting user inputs through said computer network to the base station and the at least one networked configuration.

14. The system of claim 13 wherein each data acquisition device comprises a environmentally secure body defining a transparent exterior surface and an interior space for housing;
a. a control module comprising a microprocessor, a data storage device and a software module;
b. a sensor module for gathering the plurality of environmental data;
c. a battery-free power module comprising:
i. a pair of oppositely disposed solar panels for east-west orientation;
ii. at least one super capacitor for power storage connected to said pair of oppositely disposed solar panels;
d. a communication module for communicating with the base station and an adjacent data acquisition device over a transmission range; and,
e. a first digitally encoded identification.

15. The system of claim 14 wherein the base station is selected from one of the plurality of data acquisition devices, and wherein the base station further comprises:
a. said communication module including a modem for communication with said computer network; and,
b. said software module including a sleep/wake cycle module for optimized power consumption, a data formatting sub-module for formatting the plurality of environmental data into a format suitable for the home station, a frequency allocation sub-module for efficient communications across the networked configuration and a communications sub-module comprising a neural network trained by a first algorithm for achieving power optimized data transmission; and,
c. a second digitally encoded identification.

16. The system of claim 15 wherein said sleep/wake cycle module is programmed to identify a data acquisition device within the networked configuration that is power deficient, power-down said data acquisition device for a first period of time, power-up the data acquisition device after said first period of time, receive a data transmission from the data acquisition device and, if the data acquisition device remains power deficient power-down the data acquisition device for a second period of time, or, if the data acquisition device is power sufficient permit continued normal operation of the data acquisition device.

17. The system of claim 15 wherein said frequency allocation sub-module is programmed to identify communication errors in the networked configuration caused by an over-population of data acquisition devices within the networked configuration transmitting over an assigned radio frequency, grouping said over-population into a plurality of networked sub-configurations, establishing a radio frequency bandwidth around said assigned radio frequency, assigning a portion of said radio frequency bandwidth to each of said plurality of networked sub-configurations, assigning a new digital identification to each of the networked sub-configurations and assigning a new digital identification to each of the data acquisition devices within each networked sub-configuration.

18. The system of claim 15 wherein said communications sub-module is programmed to verify a first communication path between the base station and each data acquisition device of the networked configuration, verify a second communication path between any two adjacent data acquisition devices, select an optimal communication path between each data acquisition station and the base station, identify a failed first or second communication path and select an optimal alternate communication path to circumvent said failed communication path.

19. The system of claim 15 wherein each data acquisition device of the networked configuration is operatively associated with the base station by an electronic capture of said first digitally encoded identification of each data acquisition device by the base station so that said second digitally encoded identification is electronically imprinted upon the first digitally encoded identification creating a first/second digitally encoded identification for each data acquisition device within the networked configuration.

20. The system of claim 19 wherein said electronic capture occurs when each data acquisition device is placed within sufficient proximity of the base station so that a maximum signal strength is received by the base station from the data acquisition device.
